(19) United States
(12) Patent Application Publication
(10) Pub. No.: US 2023/0262277 A1
(43) Pub. Date: Aug. 17, 2023

(54) VIEWING COMPLETION RATE ESTIMATION APPARATUS, VIEWING COMPLETION RATE ESTIMATION METHOD AND PROGRAM

(71) Applicant: Nippon Telegraph and Telephone Corporation, Tokyo (JP)

(72) Inventors: Kazuhisa YAMAGISHI, Musashino-shi, Tokyo (JP); Pierre LEBRETON, Musashino-shi, Tokyo (JP)

(21) Appl. No.: 18/012,572

(22) PCT Filed: Jul. 2, 2020
(86) PCT No.: PCT/JP2020/026019

§ 371 Date: Dec. 22, 2022

(51) Int. Cl. H04N 21/24

(52) U.S. Cl. CPC H04N 21/24

(57) ABSTRACT

A viewing completion rate estimation apparatus includes a processor configured to calculate an estimated value of a viewing completion rate per unit time based on an estimated value of video quality and a characteristic that the viewing completion rate decreases with a decrease in the video quality; and estimate a viewing completion rate for a video content length based on the estimated value of the viewing completion rate per unit time.

### TECHNICAL FIELD

The present invention relates to a viewing completion rate estimation apparatus, a viewing completion rate estimation method, and a program.

### BACKGROUND ART

Video communication services (for example, IPTV and adaptive streaming (for example, HLS and MPEG-DASH)) for transferring video media including video and audio (hereinafter, to include speech) between terminals or between a server and a terminal via the Internet have become widespread.

Since the Internet is not a network in which communication quality is necessarily guaranteed, when communication is performed using speech media, video media, or the like, a decrease in a bit rate due to a narrow line bandwidth between a viewer terminal and a network, a packet loss due to line congestion, a packet transfer delay, or packet retransmission occurs, and quality perceived by a viewer for speech media, video media, or the like deteriorates.

Specifically, since a video cannot be delivered at an excessive bit rate via a network, an original video is encoded, and the definition of the entire video is lowered when the original video is encoded because of deterioration of the video signal in a frame through processing on a per block basis or the loss of a high frequency component of the video signal. Furthermore, the delivery bit rate cannot be secured, so that the resolution of the video is lowered and the definition is lowered, or the video becomes discontinuous because the continuity of the video cannot be secured due to lowering of the frame rate. When encoded video data is transmitted as a packet to a viewer terminal via a network, if packet loss or discarding occurs, deterioration occurs in a frame/or throughput or the like decreases, so that the packet is not received by the reproduction timing, and the reproduction of the video stops due to a short of a data buffer amount in the viewer terminal.

Similarly, in a case of audio, since audio cannot be delivered at an excessive bit rate via a network, the original audio is encoded, and when the original audio is encoded, a high-frequency component of the audio is lost, and so the clarity of the audio is lost. Similar to the case of a video, when encoded audio data is transmitted as a packet to a viewer terminal via a network, if packet loss or discarding occurs, distortion occurs in the audio/or throughput or the like decreases, so that the packet is not received by the reproduction timing, and the reproduction of the audio stops due to a short of a data buffer amount in the viewer terminal.

As a result, a viewer perceives video degradation and audio degradation, and perceives degradation in audio-visual quality. This perceived deterioration in quality causes a problem that the user abandons viewing before the user finishes viewing the video completely.

In order for a service provider to provide the video communication service as described above with good quality and to reduce the viewing abandonment due to the quality degradation (thereby increasing the viewing completion rate), it is important to determine the service quality on the basis of the correspondence relationship between the quality and the viewing completion rate.

Therefore, there is a need for a viewing completion rate estimation technology capable of appropriately expressing the relationship between the audio-visual quality felt by the viewer and the viewing completion rate.

As a conventional method for evaluating the audio-visual quality, for example, there is a quality estimation method disclosed in Non Patent Literatures 1 to 5 or the like.

Specifically, there is a technology of using a transmitted packet and a setting value obtained from a service provider or the like as inputs, and deriving a short (for example, about 10 seconds) audio, video, and audio-visual quality evaluation value with respect to a length (for example, 30 minutes, 1 hour, 2 hours, or the like) of actual content in consideration of how much deterioration propagates due to a loss of a video frame caused by a packet loss (see, for example, Non Patent Literature 1).

Furthermore, there is a technology of using transmitted metadata (for example, resolution, frame rate, bit rate, and the like) regarding video delivery and a setting value (for example, a codec or the like) obtained from a service provider or the like as inputs, and deriving a short (for example, about 10 seconds) audio-visual quality evaluation value with respect to a length (for example, 30 minutes, 1 hour, 2 hours, or the like) of actual content (see, for example, Non Patent Literatures 2 to 5).

As described above, the conventional quality estimation methods are methods of estimating the audio, video, and audio-visual quality evaluation values in a short time.

### PRIOR ART LITERATURE

### Non Patent Literature

[Non Patent Literature 1] Parametric non-intrusive assessment of audiovisual media streaming quality, ITU-T P. 1201

[Non Patent Literature 2] Parametric bitstream-based quality assessment of progressive download and adaptive audiovisual streaming services over reliable transport, ITU-T P. 1203

[Non Patent Literature 3] Parametric bitstream-based quality assessment of progressive download and adaptive audiovisual streaming services over reliable transport -Video quality estimation module, ITU-T P. 1203.1

[Non Patent Literature 4] P. Lebreton and K. Yamagishi, “Transferring adaptive bit rate streaming quality models from H.264/HD to H.265/4K-UHD,” IEICE Transactions on Communications, Vol. E102-B, No. 12, pp. 2226-2242, Dec. 2019,

[Non Patent Literature 5] K. Yamagishi and T. Hayashi, “Parametric Quality-Estimation Model for Adaptive-Bitrate Streaming Services,” IEEE Transactions on Multimedia, Vol. 19, No. 7, pp. 1545-1557, 2017.

### SUMMARY OF INVENTION

### Problem to be Solved by Invention

However, since the technologies (parametric models) of Non Patent Literatures 1 to 5 estimate audio, video, and audio-visual qualities from parameters such as codec information and a bit rate, the technologies cannot directly estimate the viewing completion rate for each quality grade.

Since the video content can have any time length (for example, 30 minutes, 1 hour, 2 hours, or the like), it is necessary to be able to estimate the viewing completion rate corresponding to each video content.

The present invention has been made in view of the above points, and an object thereof is to enable estimation of a viewing completion rate of a video.

### Means to Solve Problem

Accordingly, in order to achieve the above objective, a viewing probability estimation apparatus includes: a first estimation unit that calculates an estimated value of a viewing completion rate per unit time on the basis of an estimated value of video quality and a characteristic that the viewing completion rate decreases with a decrease in the video quality; and a second estimation unit that estimates a viewing completion rate for a certain video content length on the basis of the estimated value of the viewing completion rate per unit time.

### Advantageous Effects of Invention

It is possible to estimate a viewing completion rate of a video.

### BRIEF DESCRIPTION OF DRAWINGS

FIG. 1 is a diagram illustrating a hardware configuration example of a viewing completion rate estimation apparatus 10 in an embodiment of the present invention.

FIG. 2 is a diagram illustrating a functional configuration example of the viewing completion rate estimation apparatus 10 in the embodiment of the present invention.

FIG. 3 is a flowchart for explaining an example of a processing procedure performed by the viewing completion rate estimation apparatus 10.

FIG. 4 is a diagram illustrating a relationship between a viewing completion rate and video quality (MOS) for each unit time (video content length).

### MODE FOR CARRYING OUT INVENTION

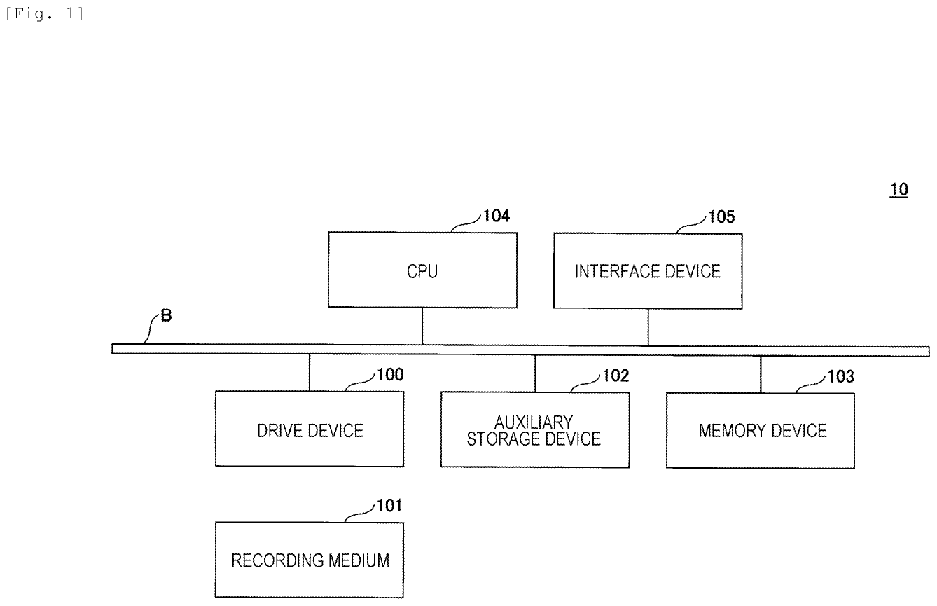

Hereinafter, embodiments of the present invention will be described with reference to the drawings. FIG. 1 is a diagram illustrating a hardware configuration example of a viewing completion rate estimation apparatus 10 in an embodiment of the present invention. The viewing completion rate estimation apparatus 10 in FIG. 1 includes a drive device 100, an auxiliary storage device 102, a memory device 103, a CPU 104, an interface device 105, and the like which are connected to each other by a bus B.

A program for implementing processing in the viewing completion rate estimation apparatus 10 is provided by a recording medium 101 such as a flexible disk or a CD-ROM. When the recording medium 101 storing the program is set in the drive device 100, the program is installed from the recording medium 101 to the auxiliary storage device 102 via the drive device 100. However, the program is not necessarily installed from the recording medium 101, and may be downloaded from another computer via a network. The program may be installed as a part of another program. The auxiliary storage device 102 stores the installed program and also stores necessary files, data, and the like.

When an instruction to start the program is provided, the memory device 103 reads and stores the program from the auxiliary storage device 102. The CPU 104 performs a function related to the viewing completion rate estimation apparatus 10 in accordance with the program stored in the memory device 103. The interface device 105 is used as an interface for connecting to a network.

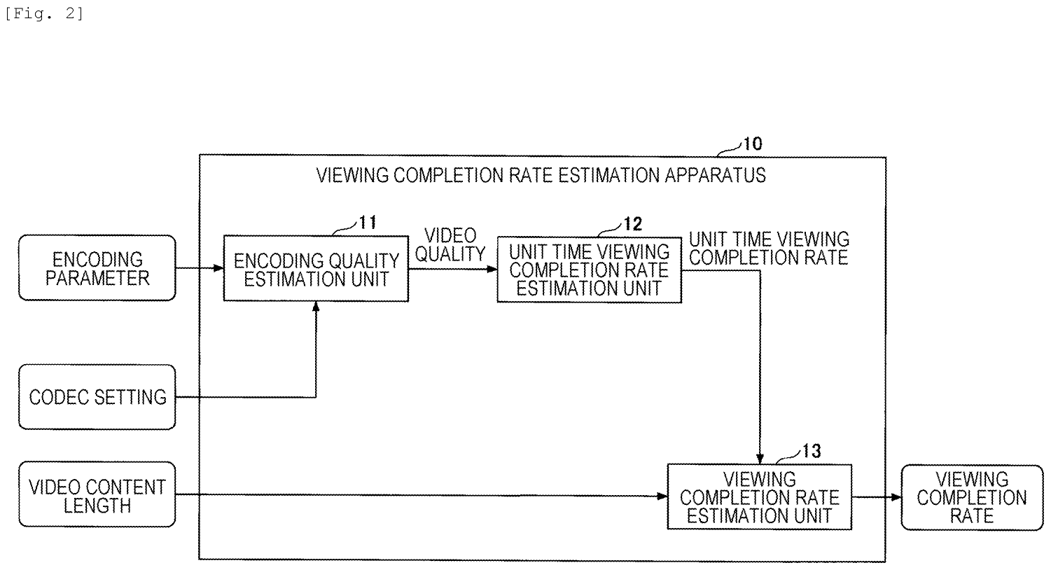

FIG. 2 is a diagram illustrating a functional configuration example of the viewing completion rate estimation apparatus 10 in the embodiment of the present invention. In FIG. 2, the viewing completion rate estimation apparatus 10 includes an encoding quality estimation unit 11, a unit time viewing completion rate estimation unit 12, and a viewing completion rate estimation unit 13 in order to estimate the viewing completion rate with respect to the quality felt by the viewer. Each of these units is implemented by processing performed by the CPU 104 by one or more programs installed in the viewing completion rate estimation apparatus 10. That is, each of these units is implemented by cooperation between hardware resources of the viewing completion rate estimation apparatus 10 and a program (software) installed in the viewing completion rate estimation apparatus 10.

The viewing completion rate refers to a probability that the content of one video is viewed up to the end.

The encoding quality estimation unit 11 uses, as an input, a codec setting (for example, a profile, the number of encoding passes, a GoP size, a motion vector search range, and the like) used in an actual service and an encoding parameter (for example, resolution, frame rate, and bit rate), and estimates encoded video quality (for example, a mean opinion score (MOS)) based on the codec setting and the encoding parameter for certain video content (hereinafter, referred to as a “target video”).

The unit time viewing completion rate estimation unit 12 receives the video quality estimated by the encoding quality estimation unit 11, and estimates a viewing completion rate (hereinafter, referred to as “unit time viewing completion rate”) per unit time (for example, 1 second, 10 seconds, 1 minute, or the like). The viewing completion rate per unit time refers to a viewing completion rate in a case where the video content length is the unit time. For example, when the unit time is one minute, the viewing completion rate per unit time refers to a viewing completion rate in a case where the video content length is one minute.

The viewing completion rate estimation unit 13 uses the video content length of the target video (original reproduction time of the target video) and the unit time viewing completion rate estimated by the unit time viewing completion rate estimation unit 12 as inputs, and estimates the viewing completion rate corresponding to the video content length.

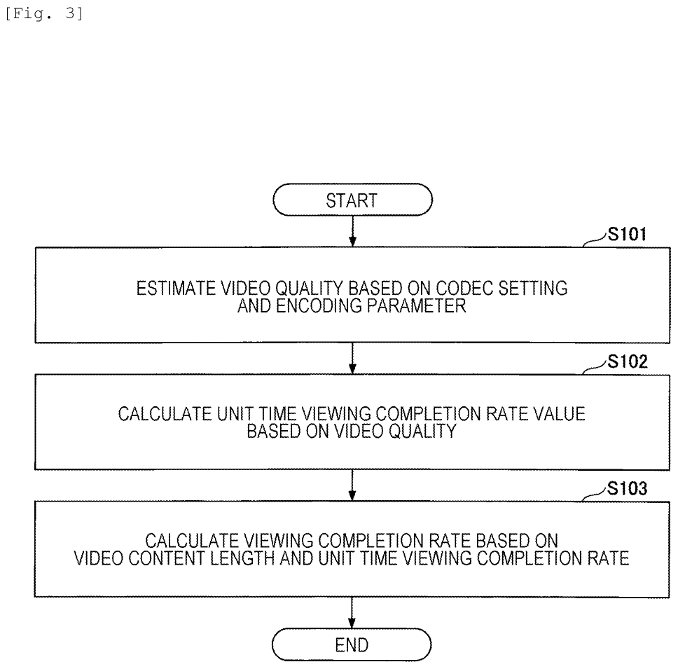

Hereinafter, a processing procedure performed by the viewing completion rate estimation apparatus 10 will be described. FIG. 3 is a flowchart for explaining an example of a processing procedure performed by the viewing completion rate estimation apparatus 10.

In step S101, when any codec setting (hereinafter, referred to as “target codec setting”) and any encoding parameter are input, the encoding quality estimation unit 11 calculates an estimated value (hereinafter, referred to as a “quality estimated value”) of the encoded video quality based on the codec setting and the encoding parameter, and outputs the quality estimated value to the unit time viewing completion rate estimation unit 12. Note that the any codec setting and the any encoding parameter are the codec setting (for example, a profile, the number of encoding passes, a GoP size, a motion vector search range, and the like) used by the provider of the video communication service in the actual service and the encoding parameter (for example, resolution, frame rate, and bit rate) used in the actual service. The video quality can be estimated using, for example, the technology disclosed in Non Patent Literatures 3 to 5 or the like.

For example, the encoding quality estimation unit 11 calculates a quality estimated value Q using the following equation based on the video quality estimation technology of Non Patent Literature 5.

$$Q = X + ( 1 - X ) / ( 1 + {( br / Y )}^{v 1} ) \\ X = \frac{4 ( 1 - exp ( - {v}_{3} fr ) ) rs}{{v}_{2} + rs} + 1 \\ Y = \frac{{v}_{4} rs + {v}_{6} {log}_{10} ( {v}_{7} fr + 1 )}{1 - {e}^{- {v}_{5} rs}} \qquad [ Math . 1 ]$$

However, rs is a resolution (for example, a total number of pixels such as 1920×1080) obtained from the number of lines and the number of pixels in the vertical and horizontal directions. However, in a case where only the number of lines in the vertical direction or the number of pixels in the horizontal direction can be recognized, rs is a resolution calculated by a known method from the number of lines or the number of pixels. fr is a frame rate. br is a bit rate. v₁, . . . , v₇ are coefficients.

Subsequently, the unit time viewing completion rate estimation unit 12 calculates an estimated value of the unit time viewing completion rate on the basis of the video quality (quality estimated value Q) estimated by the encoding quality estimation unit 11, and outputs a calculation result to the viewing completion rate estimation unit 13 (S102). At this time, the unit time viewing completion rate estimation unit 12 calculates the estimated value of the unit time viewing completion rate in consideration of also the characteristic that the viewing completion rate decreases with a decrease in video quality.

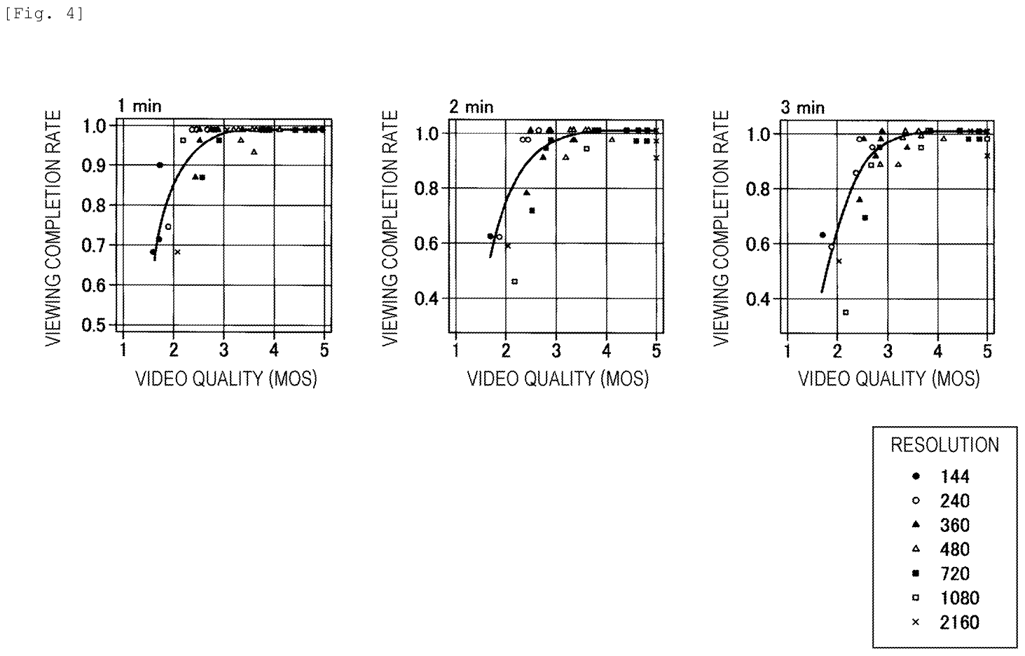

FIG. 4 is a diagram illustrating a relationship between a viewing completion rate and video quality (MOS) for each unit time (video content length). FIG. 4 illustrates relationships between the video qualities (MOS) and the viewing completion rates for unit times (video content lengths) of 1 minute, 2 minutes, and 3 minutes. As illustrated in FIG. 4, the viewing completion rate has the characteristic of decreasing as the video quality decreases.

For example, the unit time viewing completion rate estimation unit 12 calculates an estimated value of the unit time viewing completion rate C(Q) using the following equation. This equation expresses the characteristic that the viewing completion rate decreases (the viewing abandonment rate increases) as the video quality decreases.

C(Q)=1−exp (−c1×Q+c2)

Q is the above-described quality estimated value; and c1 and c2 are coefficients, and differ depending on the unit time. Therefore, the unit time viewing completion rate C(Q) is calculated on the basis of the equation corresponding to the unit time freely adopted or selected by the user. Specifically, for example, in a case where 1 minute is adopted as the unit time, the unit time viewing completion rate C(Q) is calculated in accordance with the equation (that is, in accordance with c1 and c2) approximated to the left curve in FIG. 4. In a case where 2 minutes is adopted as the unit time, the unit time viewing completion rate C(Q) is calculated in accordance with the equation (that is, in accordance with c1 and c2) approximated to the center curve in FIG. 4. In a case where 3 minutes is adopted as the unit time, the unit time viewing completion rate C(Q) is calculated in accordance with the equation (that is, in accordance with c1 and c2) approximated to the right curve in FIG. 4. The equation for calculating the unit time viewing completion rate C(Q) is not limited to the above equation as long as the equation can account for the characteristic that the viewing completion rate decreases as the video quality decreases.

Subsequently, the viewing completion rate estimation unit 13 calculates the viewing completion rate with respect to the target codec setting on the basis of any amount of video content length (for example, the video content length input by the user) and the unit time viewing completion rate, and outputs the viewing completion rate (S103).

It can be seen from FIG. 4 that the longer the video content length, the higher the video quality to be maintained needs to be in order to achieve the same viewing completion rate. For example, as illustrated in FIG. 4, the video quality (MOS) required to achieve a viewing completion rate of 90% is about 2.1 for video content of 1 minute, about 2.5 for video content of 2 minutes, and about 2.7 for video content of 3 minutes. On the basis of this characteristic, the viewing completion rate estimation unit 13 calculates the viewing completion rate for the target codec setting from the video content length and the unit time viewing completion rate.

For example, the viewing completion rate estimation unit 13 estimates the viewing completion rate C(Q,t) using the following equation. This equation expresses a characteristic that the viewing completion rate decreases as the video content length increases unless the video quality is high (that is, if the unit time viewing completion rate is not high). The characteristic that the viewing completion rate decreases unless the unit time viewing completion rate is high is, in other words, a characteristic that the viewing completion rate decreases as the unit time viewing completion rate decreases.

C(Q,t)=[C(Q)]^{t}

C(Q) is the above-described unit time viewing completion rate. t represents a video content length (minutes).

In order to control the decrease in the viewing completion rate with respect to the video content length, any of the following equations to which the coefficient c3 or further the coefficient c4 is added may be used.

C(Q,t)=[C(Q)]^{c3·t}

C(Q,t)=[C(Q)]^{(c3·t+c4)}

C(Q) is the above-described unit time viewing completion rate. t represents a video content length (minutes). c3 and c4 are coefficients. The equation for calculating the viewing completion rate is not limited to the above equation as long as the equation can account for the characteristic that the viewing completion rate decreases unless the viewing completion rate per unit time is high as the video content length increases.

As described above, according to the present embodiment, the viewing completion rate of the video can be estimated for each codec setting.

Although a conventional quality estimation technology for estimating video quality has been established, there has been a problem that an increase in viewing abandonment (a decrease in viewing completion) due to a decrease in quality cannot be recognized. On the other hand, in the present embodiment, the viewing completion rate can be mechanically estimated.

As a result, since the provider of the video communication service can recognize the viewing completion rate of the video communication service actually viewed by the viewer, for example, it is possible to avoid creating a video having a significantly low viewing completion rate. Therefore, it is possible to improve the viewing completion rate of the video delivery scheduled to be provided.

In the present embodiment, the unit time viewing completion rate estimation unit 12 is an example of a first estimation unit. The viewing completion rate estimation unit 13 is an example of a second estimation unit.

Although the embodiments of the present invention have been described in detail above, the present invention is not limited to such specific embodiments, and various modifications and changes can be made within the scope of the concept of the present invention described in the claims.

### DESCRIPTION OF REFERENCE SIGNS

10 Viewing completion rate estimation apparatus
11 Encoding quality estimation unit
12 Unit time viewing completion rate estimation unit
13 Viewing completion rate estimation unit
100 Drive device
101 Recording medium
102 Auxiliary storage device
103 Memory device

### 104 CPU

105 Interface device

### B Bus

1. A viewing completion rate estimation apparatus comprising a processor configured to:
calculate an estimated value of a viewing completion rate per unit time based on an estimated value of video quality and a characteristic that the viewing completion rate decreases with a decrease in the video quality; and
estimate a viewing completion rate for a video content length based on the estimated value of the viewing completion rate per unit time.

2. The viewing completion rate estimation apparatus according to claim 1,
wherein the processor is configured to estimate the viewing completion rate for the video content length based on a characteristic that the viewing completion rate decreases as the viewing completion rate per unit time decreases with an increase in the video content length.

3. A viewing completion rate estimation method comprising:
calculating, by a processor, an estimated value of a viewing completion rate per unit time based on an estimated value of video quality and a characteristic that the viewing completion rate decreases with a decrease in the video quality; and
estimating, by the processor, a viewing completion rate for a certain video content length based on the estimated value of the viewing completion rate per unit time.

4. The viewing completion rate estimation method according to claim 3,
wherein the processor is configured to estimate the viewing completion rate for the certain video content length is based on a characteristic that the viewing completion rate decreases as the viewing completion rate per unit time decreases with an increase in the video content length.

5. A non-transitory computer-readable medium storing a program causing a processor to:
calculate an estimated value of a viewing completion rate per unit time based on an estimated value of video quality and a characteristic that the viewing completion rate decreases with a decrease in the video quality; and
estimate a viewing completion rate for a video content length based on the estimated value of the viewing completion rate per unit time.

6. The non-transitory computer-readable medium according to claim 5,
wherein the program is further configured to estimate the viewing completion rate for the video content length based on a characteristic that the viewing completion rate decreases as the viewing completion rate per unit time decreases with an increase in the video content length.
